(19) United States
(12) Patent Application Publication
(10) Pub. No.: US 2006/0184386 A1
(43) Pub. Date: Aug. 17, 2006

(54) Methods and systems for providing combination gift card and greeting card

(76) Inventor: Jeffrey R. Merritt, Alexandria, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/405,490

(22) Filed: Apr. 18, 2006

Related U.S. Application Data
(63) Continuation-in-part of application No. 10/953,529, filed on Sep. 30, 2004.
(60) Provisional application No. 60/584,530, filed on Jul. 2, 2004.

(51) Int. Cl. G06Q 99/00

(52) U.S. Cl. 705/1

(57) ABSTRACT

Systems and methods for providing a combination gift element and greeting element may comprise receiving a request to create a greeting element, the greeting element comprising at least one of an electronic greeting element and a physical greeting element. Furthermore, the systems and methods may include receiving a request to associate a gift element with the greeting element, the gift element comprising at least one of an electronic gift element and a physical gift element. Moreover, the systems and methods may include creating the combination gift element and greeting element based upon the received request to create the greeting element and the received request to associate the gift element with the greeting element. In addition, the systems and methods may include sending the combination gift element and greeting element to a recipient over at least one of a network and an item delivery system.

### RELATED APPLICATION

This application is a continuation-in-part of U.S. non-provisional application Ser. No. 10/953,529, filed Sep. 30, 2004, and further, claims the benefit of priority of U.S. provisional application No. 60/584,530, filed Jul. 2, 2004, the technical disclosure of which is hereby incorporated herein by reference.

### BACKGROUND

1. Technical Field

The present invention generally relates to providing a gift card. More particularly, the present invention relates to providing a combination gift card and greeting card.

2. Background

The United States Postal Service (USPS) is an independent government agency that provides mail delivery and other services to the public. The USPS is widely recognized as a safe and reliable means for sending and receiving mail and other items. With the advent and steady growth of electronic mail and electronic commerce, the physical mail stream will increasingly be utilized for sending and receiving mailpieces, packages, and other items.

Moreover, gift cards, which may comprise, for example, pre-paid elements redeemable at a retail store for items available through the retail store, account for a significant percentage of retail revenues, with 500 million gift cards issued each year in the U.S. In 2001, 18 billion dollars worth of gift cards and certificates were issued in the U.S. alone with the trend moving toward plastic gift cards. Industry analysts project that 60% of retailers expect to convert from paper gift certificates to plastic cards by 2005.

A 2003 survey of 1,023 U.S. adults aged 18 or older revealed that consumer awareness of gift cards has reached 92 percent, a 13 percent increase over 2002. Nearly 6 in every 10 adults (59 percent) reported purchasing and/or receiving a gift card in the past year, a 22 percent increase over 2002 findings. Surveys also indicate that consumers increased the number of cards they purchased to an average of 5.6 cards per year, an increase of over one card from the previous year. Households with teenagers purchased 7.5 cards per year, nearly two cards over the average. Overall, consumers spent an average of $197 on their purchased gift cards in the previous year.

Consequently, providing gift cards is desired. Great inefficiencies are created in conventional gift card providing systems because, for example, they do not allow a sender to easily combine a greeting card with the gift card. Accordingly, providing a combination gift card and greeting card is desired. Thus, there remains a need for efficiently providing a gift card. In addition, there remains a need for efficiently providing a combination gift card and greeting card.

### SUMMARY

In embodiments consistent with the present invention, systems and methods are disclosed for providing a combination gift card and greeting card.

Consistent with one aspect of the invention, there is provided a multi-entity method for providing a combination gift element and greeting element that comprises receiving a request to create a greeting element, the greeting element comprising at least one of an electronic greeting element and a physical greeting element, and receiving a request to associate a gift element with the greeting element, the gift element comprising at least one of an electronic gift element and a physical gift element. The method further comprises creating the combination gift element and greeting element based upon the received request to create the greeting element and the received request to associate the gift element with the greeting element; and sending the combination gift element and greeting element to a recipient over at least one of a network and an item delivery system.

Consistent with another aspect of the invention, there is provided a system for providing a combination gift element and greeting element comprises a memory storage for maintaining a database and a processing unit coupled to the memory storage. Further, the processing unit is operative to receive a request to create a greeting element, wherein receiving the request to create the greeting element further comprises receiving a request to personalize the greeting element with an image; receive a request to associate a gift element with the greeting element; and create the combination gift element and greeting element based upon the received request to create the greeting element and the received request to associate the gift element with the greeting element.

Consistent with another aspect of the invention, there is provided a system for providing a combination gift element and greeting element comprises a memory storage for maintaining a database and a processing unit coupled to the memory storage. Further, the processing unit is operative to receive a request to create a greeting element, wherein receiving the request to create the greeting element further comprises receiving a request to personalize a stamp for an envelope, containing the combination gift element and greeting element, with an image; receive a request to associate a gift element with the greeting element; and create the combination gift element and greeting element based upon the received request to create the greeting element and the received request to associate the gift element with the greeting element.

Consistent with another aspect of the invention, there is provided a system for providing a combination gift element and greeting element comprises a memory storage for maintaining a database and a processing unit coupled to the memory storage. Further, the processing unit is operative to receive a request to create a greeting element, wherein receiving the request to create the greeting element further comprises receiving a request to associate a photographic print with the combination gift element and greeting element; receive a request to associate a gift element with the greeting element; and create the combination gift element and greeting element based upon the received request to create the greeting element and the received request to associate the gift element with the greeting element.

Consistent with another aspect of the invention, there is provided a computer-readable medium which stores a set of instructions which when executed on a processor performs a multi-entity method for providing a combination gift element and greeting element. The method is executed by the set of instructions comprising receiving a request to create a gift element with the greeting element; receiving a request to associate a gift element with the greeting element; and creating the combination gift element and greeting element based upon the received request to create the greeting element and the received request to associate the gift element with the greeting element.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects consistent with the present invention. In the drawings:

FIG. 1 is a block diagram of an exemplary combination gift element and greeting element providing system consistent with the present invention;

FIG. 2 is a block diagram of an exemplary item delivery system consistent with the present invention;

FIG. 3 is a flow chart of an exemplary method for providing a combination gift element and greeting element consistent with the present invention;

FIG. 4 is a block diagram of an exemplary combination gift element and greeting element and delivery system consistent with the present invention; and

FIG. 5 is a block diagram of another exemplary combination gift element and greeting element and delivery system consistent with the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with the invention may provide a combination gift card and greeting card. For example, a customer purchasing a greeting card could also enclose with the greeting card, a gift card for the greeting card's recipient. The gift card may comprise a pre-paid card redeemable at a retail store for items available through the retail store. The combination gift card and greeting card may be purchased on-line or at a retail point-of-sale. Furthermore, the combination gift card and greeting card may comprise a physical element that may be sent through an item delivery system such as provided by the USPS or other delivery system operator. In addition, the combination gift card and greeting card may comprise an electronic file capable of being transferred over a network such as the Internet, for example.

Consistent with the invention, an enterprise such as a delivery system operator may operate a greeting card service capable of creating and sending a greeting card to a recipient. For example, the USPS may operate a greeting card service as a part of a suite of services. This service, for example, may combine the convenience of the Internet with the effectiveness of traditional hard-copy mail to help strengthen customer loyalty, improve customer retention, cross-sell, up-sell, and effectively follow-up sales or marketing efforts. Output of this service may include full-color 5×7 folded, enveloped, and stamped greeting cards. With just a few mouse clicks, a user can open an account, upload images, logos and address lists, and even create a business account. Whether to one recipient or thousands, greeting cards created through the service may be automated and standardized with addresses and proper postage. Created greeting cards may be printed, processed, and entered into an item delivery system, such as the USPS, the next business day, for example. The USPS is exemplary, and other delivery services may be used.

Moreover, users may personalize their greeting cards by occasion and with personal messages and may even choose a special stamp or other indicia for an envelope containing the greeting card. Users may also personalize their greeting cards and stamps by incorporating an uploaded image into the greeting card and/or stamp. The combination gift card and greeting card may be further customized by associating one or more separate photographic prints with the combination gift card and greeting card.

Furthermore, a retailer may offer a gift card for sale through an internet site. In addition to the gift card, a customer may also choose a greeting card option on the retailer's internet site associated with the gift card. Accordingly, the user may create a combination gift card and greeting card through a retailer's Internet site. The combination gift card and greeting card may be configured to be sent to a recipient through an item delivery system such as the USPS. For example, the retailer's Internet site may utilize a delivery service provided by a delivery system operator. Moreover, a delivery system operator, such as the USPS, may collaborate with one retailer in a particular industry. Accordingly, co-branding between a particular retailer and a particular delivery system operator may be created.

An embodiment consistent with the invention may comprise a system for providing a combination gift element and greeting element. The system may comprise a memory storage for maintaining a database and a processing unit coupled to the memory storage. The processing unit may be operative to receive a request to create a greeting element. The greeting element may comprise one of an electronic greeting element and a physical greeting element. The processing unit may be further operative to receive a request to associate a gift element with the greeting element. The gift element may comprise one of an electronic gift element and a physical gift element. Moreover, the processing unit may be operative to create the combination gift element and greeting element based upon the received request to create the greeting element and the received request to associate the gift element with the greeting element. Furthermore, the processing unit may be operative to send the combination gift element and greeting element to a recipient over at least one of a network and an item delivery system.

Furthermore, any system or component of the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

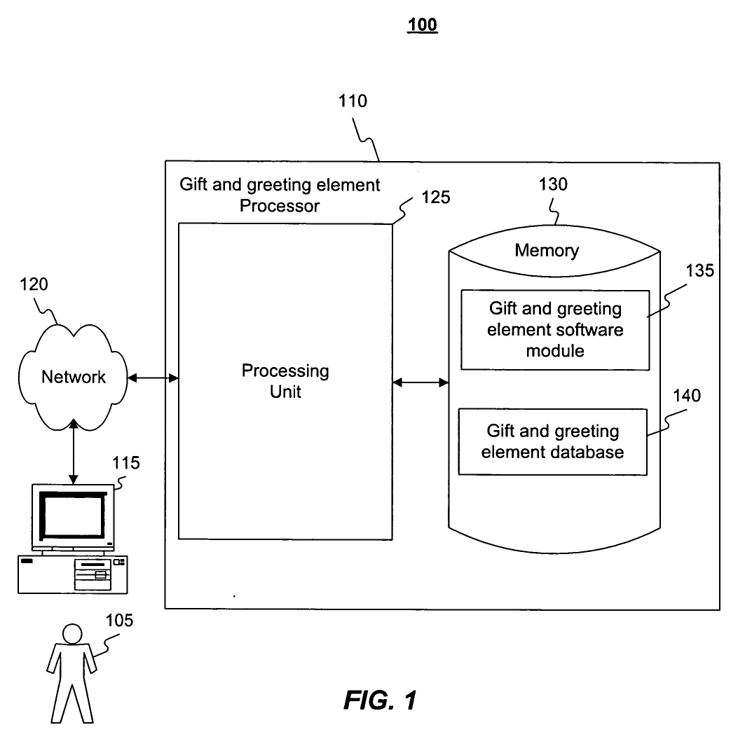

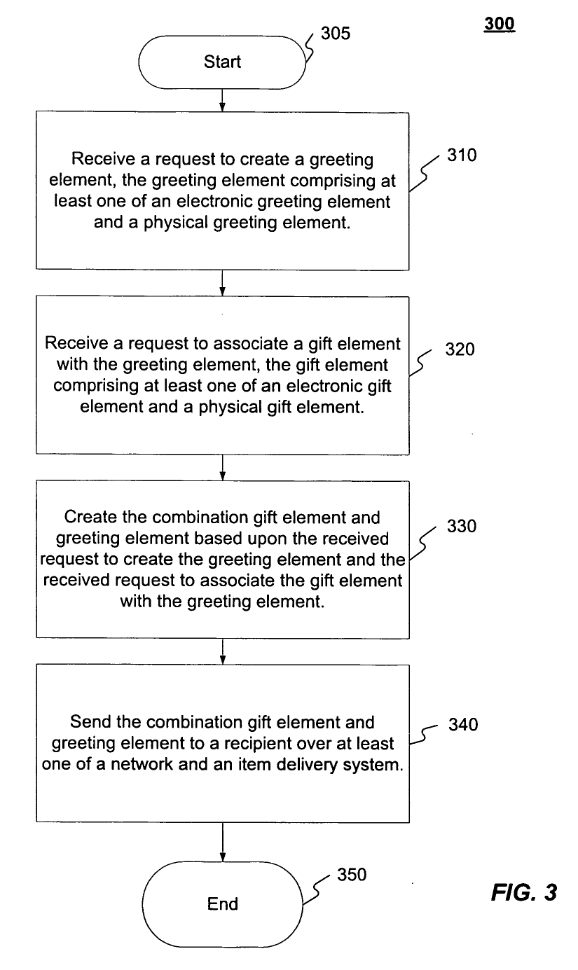

As illustrated in the block diagram of FIG. 1, system 100 may include a user 105, processors 110 and 115, and a network 120. Processor 110 may include a processing unit 125 and a memory 130. Memory 130 may include a gift and greeting element software module 135 and a gift and greeting element database 140. For example, software module 135, executed on processing unit 125, may access database 140 and implement processes for providing a combination gift element and greeting element to implement a method such as the method described below with respect to FIG. 3.

Processors 110 and 115, or any other processor included in system 100 (“the processors”), may be implemented using a personal computer, network computer, mainframe, or other similar microcomputer-based workstation. The processors, however, may comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 120 may comprise, for example, a local area network (LAN) or a wide area network (WAN). Such networking environments are commonplace in offices, enterprise-wide computer networks, intranets, and the Internet, and are known by those skilled in the art. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. It may be appreciated, however, that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit data by methods and processes other than, or in combination with, network 120. These methods and processes may include, but are not limited to, transferring data via, diskette, CD ROM, flash memory sticks, facsimile, conventional mail, an interactive voice response system (IVR), or via voice over a publicly switched telephone network.

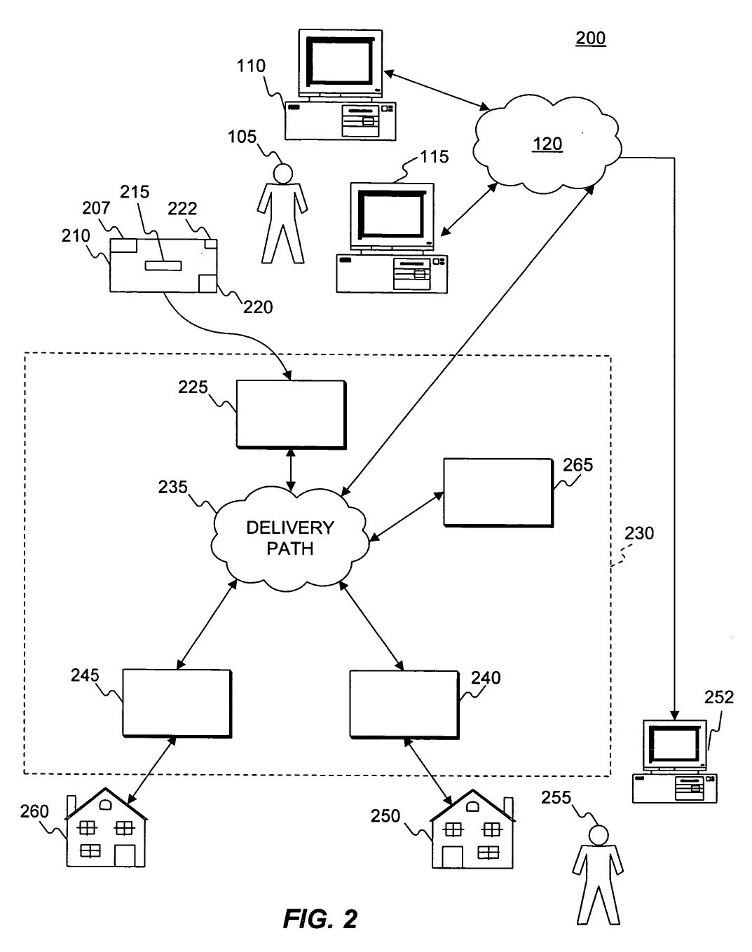

By way of a non-limiting example, FIG. 2 illustrates an exemplary delivery system 200 in which the features and principles consistent with the present invention may be implemented. For example, once the combination gift element and greeting element is created, a user 105, for example, may place an item 210 comprising the combination gift element and greeting element into a delivery system 230. Item 210 may contain a label 215 indicating a first address at a location 250 of a recipient 255 and a return address 207 indicating where to return item 210 if necessary. Item 210 may also contain a tracking indicia 220 relating to, for example, user 105 and recipient 255. Tracking indicia 220 may be placed on item 210 by user 105 or the operator of delivery system 230. User 105 may be, for example, a user working with an enterprise that provides the combination gift element and greeting element. User 105 may also be an organization, enterprise, or any other entity having such needs. Furthermore, user 105 may comprise an individual who purchases the combination gift element and greeting element and places it in item delivery system 230. In addition, item 210 may include a delivery payment coding 222. Delivery payment coding 222 may indicate that user 105 has paid a fee required by the delivery system operator to deliver item 210 to location 250 of recipient 255. Delivery payment coding 222 may comprise a bar code, an image indicating an account from which delivery payment has been made, a postage stamp, or any other coding type. Recipient 255 may have access to a recipient processor 252, which may be, for example, a personal computer.

Item 210 may be routed through delivery system 230, which may comprise a plurality of facilities, including a sender plant 225, a delivery path 235, a first address plant 240, an alternative address plant 245, and an alternative processing point 265. Delivery system 230 may comprise a plurality of plants similar to sender plant 225, first address plant 240, and alternative address plant 245. The plants within delivery system 230 may contain, among other things, scanning equipment designed to scan and read tracking indicia on items processed by plants within delivery system 230. For example, delivery system 230 may be configured to sense tracking indicia 220 on item 210 with the scanning equipment as item 210 passes through the elements of delivery system 230. Accordingly, delivery system 230 may collect tracking data corresponding to movement of item 210 through delivery system 230 and provide this tracking data to processors 110 or 115, for example. System 200 may also include network 120 as described in detail above. Any or all of the systems or components of system 200 may communicate using network 120.

Tracking indicia 220 may comprise a bar code or a PLANET code, to be described below. A bar code is a printed code used for recognition by a bar code scanner (reader). Traditional one-dimensional bar codes use the width of the bar to encode a product or account number. Two-dimensional bar codes, such as PDF417, MAXICODE and DATAMATRIX, are scanned horizontally and vertically and hold considerably more data. Generally, PDF417 is widely used for general purposes, MAXICODE is used for high-speed sorting, and DATAMATRIX is used for marking small parts.

Historically, delivery system operators sorted flat mail using a barcode such as POSTNET, a 22-digit barcode consisting of alternating long and short bars indicating the destination of, for example, a mailpiece. Responding to the expanding needs of users who are particularly heavy volume users, PLANET code was developed on the foundation of the existing technical infrastructure. The PLANET code is the opposite of the POSTNET code, reversing long bars for short and short bars for long. This innovation offers the convenience of a bar code that is easily applied using current bar-coding methods, and is readily scanned by the high-speed automation equipment located in the plurality of plants comprising delivery system 230.

Item 210 may be sent through delivery system 230 by user 105 to first address plant 240. At any time in the delivery process, a determination may be made as to whether item 210 is undeliverable (including undeliverable-as-addressed.) If it is determined that item 210 is undeliverable-as-addressed, item 210 may be forwarded to alternative processing point 265 where an ancillary service may be performed. Examples of such ancillary services may include recycle service (treating item 210 as waste), “NIXIE” service, and Computerized Forwarding Service (CFS).

With respect to NIXIE service, NIXIE is a classification given to an item that cannot be sorted or is undeliverable-as-addressed because of an incorrect, illegible, or insufficient delivery address. If item 210 is undeliverable-as-addressed, address correction service (re-label with a correct address) or return service (return item to the sender) may be performed. In this case, a NIXIE operator specialized in the handling of such items may be required. If item 210 requires return service, return address 207 on item 210 may be read and item 210 may be sent to return address 207 accordingly. Return address 207 may be an element of item 210 that is usually placed in the upper left corner of item 210 to indicate the address of user 105. This address may indicate where user 105 may want item 210 returned if it is undeliverable (including undeliverable-as-addressed.) In addition return address 207 may indicate where user 105 may receive a bill for any fees due for the return of item 210. When item 210 requires address correction service, a NIXIE operator may obtain the proper address of recipient 255 or the reason for non-delivery. While NIXIE processing may comprise address correction service or return service, other types of NIXIE processing may be performed.

Computerized forwarding service may be a centralized, computerized address label-generating operation that forwards undeliverable-as-addressed items to recipients in this case, recipient 255 may pre-register an alternative address 260 of recipient 255 with the delivery system operator in order to have all items forwarded to alternative address 260. For example, if recipient 255 moves and wishes to have items sent to alternative address 260, recipient 255 may notify the delivery system operator of alternative address 260. Once the delivery system operator is notified of alternative address 260, all items sent to first address 250 may be detected by delivery system 230, re-labeled, and then forwarded to alternative address 260. In the aforementioned computerized forwarding service, items may be forwarded only for a specific period of time, thus providing recipient 255 time to contact each and every sender who recipient 255 may expect to send an item and notify the possible senders of the address change of recipient 255. After the computerized forwarding service time period is complete, the delivery system operator may cease forwarding items to recipient 255 and may return to the user 105 all items sent to first address 250.

If ancillary services were required, item 210 may remain at alternative processing point 265 or may be processed at an item recovery section of alternative processing point 265. Item 210 may be recovered by user 105 or recipient 255 upon the completion of a “tracer”. A tracer is a paper or electronic form completed by user 105 or recipient 255 to locate delayed or undelivered items (including items undeliverable-as-addressed). While item recovery may occur at alternative processing point 265, other types of processing may be performed at alternative processing point 265.

While processor 110 is shown to be separate from delivery system 230, the functionality of processor 110 may be performed under the control of the delivery system operator at alternative processing point 265, at any point within delivery system 230, or at any point outside delivery system 230. Moreover, the functionality of processor 110 may be performed by an enterprise not under the control of the delivery system operator. Moreover, the delivery system operator may communicate over network 120 with user processor 115.

FIG. 3 is a flow chart setting forth the general stages involved in an exemplary method 300 consistent with the invention for providing a combination gift element and greeting element using system 200 of FIG. 2. Exemplary ways to implement the stages of exemplary method 300 will be described in greater detail below. Exemplary method 300 may begin at starting block 305 and proceed to stage 310 where processor 110 may receive a request to create a greeting element. The greeting element may comprise at least one of an electronic greeting element and a physical greeting element. For example, user 105 (FIG. 1), using processor 115, may send over network 120 the request to create the greeting element. The request may include an indication to create an electronic greeting element or a physical greeting element. The physical greeting element may comprise a greeting card capable of being sent to location 250 of recipient 255 through item delivery system 230. Furthermore, the greeting element may comprise an electronic greeting element that may be sent to processor 252 of recipient 255 over network 120.

From stage 310 where processor 110 receives the request to create the greeting element, exemplary method 300 may then proceed to stage 320 where processor 110 may receive a request to associate a gift element with the greeting element. The gift element may comprise at least one of an electronic gift element and a physical gift element. For example, user 105, using processor 115, may send over network 120 the request to associate the gift element with the greeting element. The physical gift element may comprise a gift card capable of being sent to recipient 255 through item delivery system 230. For example, the gift card may be placed with the greeting card in item 210 and sent to recipient 255 through item delivery system 230. Furthermore, the gift element may comprise an electronic gift element that may be sent to recipient 255 over network 120 along with the electronic greeting element.

Once processor 110 receives the request to associate the gift element with the greeting element in stage 320, exemplary method 300 may continue to stage 330 where processor 110 may create the combination gift element and greeting element based upon the received request to create the greeting element and the received request to associate the gift element with the greeting element. For example, processor 110 may create the combination gift element and greeting element capable of either being sent to recipient 255 through item delivery system 230 or over network 120, as specified in the received request. Next, exemplary method 300 may advance to stage 340 where processor 310 may send the combination gift element and greeting element to recipient 255 over network 120 or item delivery system 230. From stage 310 where processor 310 send the combination gift element and greeting element to the recipient, exemplary method 300 may end at stage 350.

Consistent with embodiments of the invention, the combination gift element and greeting element, in the form of a physical delivery item, may be sent to recipient 255 over item delivery system 230 to first address location 250 comprising a delivery point. The delivery point may be a physical place to which a delivery system operator may deliver an item. A delivery point may be, for example, a street letterbox, a door slot, an apartment building box cluster, or a separate post office box. The aforementioned are exemplary, and delivery points may comprise any location where an item may be received. Furthermore, an item may comprise a mailpiece, a United States Postal Service Priority Mail package, a United States Postal Service Express Mail Package, or any other item to be delivered. The aforementioned are exemplary and the item may comprise any deliverable element.

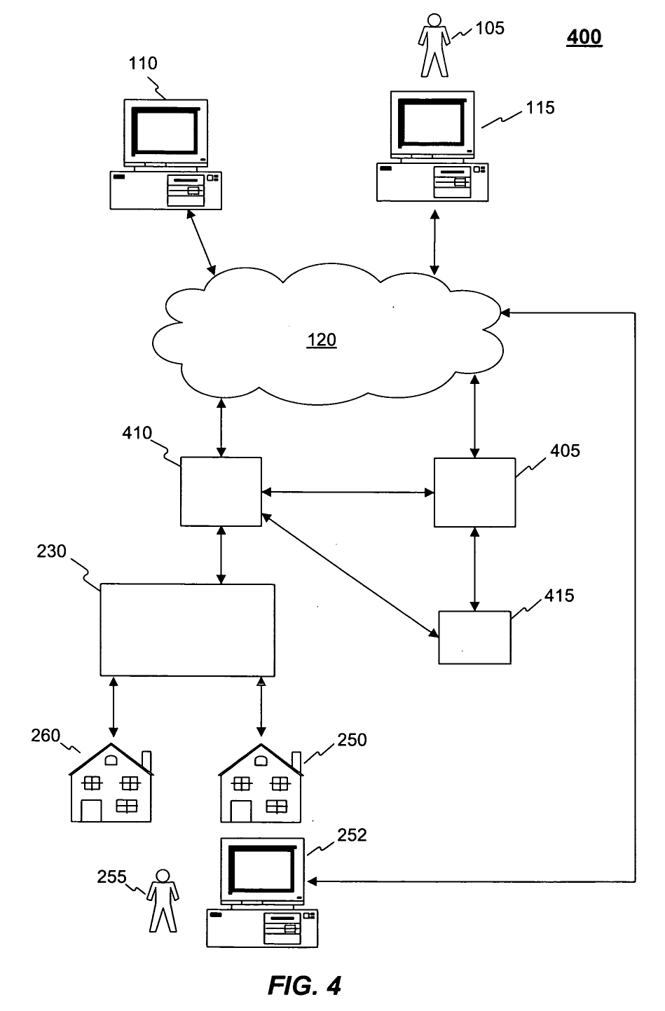

By way of a non-limiting example, FIG. 4 illustrates an exemplary business process 400, in which the features and principles consistent with the present invention may be implemented. Process 400 includes of entities such as, for example, service provider 405, third party 410, and retailer 415, which are distinct from user 105. In more detail, user 105 operates a user processor 115, to interact with network 120 and processor 110, and communicate with service provider 405. Service provider 405 can then communicate with third party 410 over network 120 and directly. Retailers 415 may enter the process 400 through communication with third party 410. Third party 410 utilizes delivery system 230 to deliver a product to recipient 255 at either delivery address 250 or alternative delivery address 260. Further, recipient 255 may interact with network 120 through processor 252.

Process 400 allows user 105 to combine a greeting card with a gift card from retailer 415. User 105 utilizes network 120 to communicate with service provider 405, and may select to combine a greeting card with a gift card from retailer 415. Retailer 415 enters process 400 by communicating with, and providing gift cards to, third party 410. Additionally, third party 410 may communicate with service provider 405 to enable them to offer retailer gift cards. The gift cards provided by retailer 415 can be pre-activated by the retailer for a predetermined value. Alternatively, the gift cards provided by retailer 415 may be inactive, such that third party 410 can activate the gift card, for a value selected by user 105, from a predetermined set of values selected by retailer 415.

After user 105 has communicated with service provider 405 to combine a gift card, from retailer 415, with a greeting card, user 105 is connected with third party 410 over network 120. User 105 is then capable of selecting and communicating the combination gift card and greeting card information, along with a fee, to third party 410. Additionally, third party 410 transfers a portion of the fee to both service provider 405 and retailer 415. Further, third party 410 implements delivery system 230 to deliver the combination gift card and greeting card to recipient 255. Recipient 255, can use processor 252 to make an inquiry, or submit information, regarding the delivery by communicating with service provider 405 over network 120.

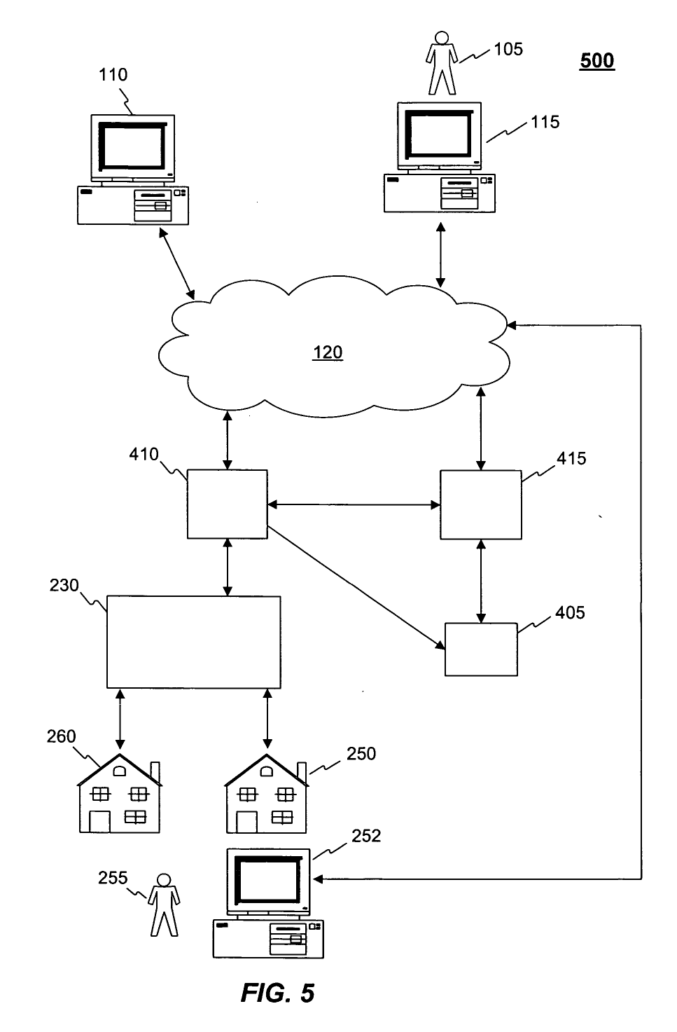

Referring to FIG. 5, shown is an exemplary alternate business process 500 in which the features and principles consistent with the present invention may be implemented. For example, service provider 405 is in communication with third party 410. Further, user 105 operates user processor 115, to interact with network 120 and processor 110, and to communicate with third party 410. Third party 410 can then communicate with retailer 415 for the transfer of retailer gift cards, either directly and/or over network 120. Retailer 415 can then communicate with third party 120 for the transfer of retailer gift cards, either directly and/or over network 120.

Moreover, third party 410 utilizes delivery system 230 to deliver a product to recipient 255 at either delivery address 250 or alternative delivery address 260. Further, recipient 255 may interact with network 120 through processor 252.

Generally, process 500 allows a user 105 to combine a greeting card with a gift card from a retailer 415. User 105 utilizes a network 120 to communicate with third party 410, and may choose to combine a greeting card with a retailer gift card. Both third party 410 and retailer 415 are authorized to use process 500 by service provider 405.

User 105 communicates with third party 410 to combine a retailer gift card with a greeting card over a network 120. User 105 is then capable of selecting and communicating the combination gift card and greeting card information, along with a fee, to third party 410. Additionally, third party 410 transfers a portion of the fee to both service provider 405 and retailer 415. Further, third party 410 implements delivery system 230 to deliver the combination gift card and greeting card to recipient 255. Recipient 255, can use processor 252 to make an inquiry, or submit information, regarding the delivery by communicating with service provider 405 over network 120.

Alternatively, user 105 of process 500, may operate processor 115, to interact with network 120, and to communicate with retailer 415. After user 105 has communicated with retailer 415 to combine a retailer gift card with a greeting card, user 105 is connected with third party 410 over network 120. User 105 is then capable of selecting and communicating the combination gift card and greeting card information, along with a fee, to third party 410. Additionally, third party 410 transfers a portion of the fee to both service provider 405 and retailer 415. Further, third party 410 implements delivery system 230 to deliver the combination gift card and greeting card to recipient 255. Recipient 255, can use processor 252 to make an inquiry, or submit information, regarding the delivery by communicating with service provider 405 over network 120.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for providing a combination gift element and greeting element, the method comprising:
receiving a request to create a gift element with the greeting element;
receiving a request to associate a gift element with the greeting element; and
creating the combination gift element and greeting element based upon the received request to create the greeting element and the received request to associate the gift element with the greeting element,
wherein creating the combination gift element and greeting element employs the involvement of multiple entities.

2. The method of claim 1, further comprising receiving the request to create the combination gift element and greeting element from a retailer.

3. The method of claim 2, further comprising transferring the request to create the combination gift element and greeting element from a retailer to a third party.

4. The method of claim 2, further comprising transmitting authorization to the retailer and to the third party, by the service provider, to create the combination gift element and greeting element.

5. The method of claim 1, further comprising receiving the request to create the combination gift element and greeting element at a service provider.

6. The method of claim 5, further comprising transferring the request to create the combination gift element and greeting element from a service provider to a third party.

7. The method of claim 5, further comprising transmitting authorization for the third party to offer a retailer gift element by the retailer.

8. The method of claim 1, further comprising initiating the request to create the combination gift element and greeting element at a third party.

9. The method of claim 8, further comprising transmitting authorization to the third party to offer a retailer gift element by the retailer.

10. The method of claim 8, further comprising transmitting authorization to the third party, by the service provider, to create the combination gift element and greeting element.

11. The method of claim 1, wherein the gift element is a retailer gift element.

12. The method of claim 1, further comprising configuring the combination gift element and greeting element to be sent over at least one of a network and an item delivery system, by the third party.

13. The method of claim 1, further comprising implementing a network to acquire information about the combination gift element and greeting element, by a recipient.

14. The method of claim 1, further comprising implementing a network to submit information about the combination gift element and greeting element, by a recipient.

15. The method of claim 1, further comprising receiving a request to personalize the greeting element with an image.

16. The method of claim 1, further comprising receiving a request to personalize a stamp for an envelope containing the combination gift element and greeting element with an image.

17. The method of claim 1, further comprising receiving a request to associate a photographic print with the combination gift element and greeting element.

18. The method of claim 1, further comprising including a tracking indicia on an envelope containing the combination gift element and greeting element.

19. The method of claim 1, further comprising collecting a fee by a third party.

20. The method of claim 19, further comprising the third party sharing the fee with a retailer and a service provider.

21. A system for providing a combination gift element and greeting element, the system comprising:
a memory storage for maintaining a database; and
a processing unit coupled to the memory storage, wherein the processing unit is operative to
receive a request to create a greeting element,
wherein receiving the request to create the greeting element further comprises receiving a request to personalize the greeting element with an image;
receive a request to associate a gift element with the greeting element; and
create the combination gift element and greeting element based upon the received request to create the greeting element and the received request to associate the gift element with the greeting element.

22. A system for providing a combination gift element and greeting element, the system comprising:
a memory storage for maintaining a database; and
a processing unit coupled to the memory storage, wherein the processing unit is operative to
receive a request to create a greeting element,
wherein receiving the request to create the greeting element further comprises receiving a request to personalize a stamp for an envelope, containing the combination gift element and greeting element, with an image;
receive a request to associate a gift element with the greeting element; and
create the combination gift element and greeting element based upon the received request to create the greeting element and the received request to associate the gift element with the greeting element.

23. A system for providing a combination gift element and greeting element, the system comprising:
a memory storage for maintaining a database; and
a processing unit coupled to the memory storage, wherein the processing unit is operative to
receive a request to create a greeting element,
wherein receiving the request to create the greeting element further comprises receiving a request to associate a photographic print with the combination gift element and greeting element;
receive a request to associate a gift element with the greeting element; and
create the combination gift element and greeting element based upon the received request to create the greeting element and the received request to associate the gift element with the greeting element.

24. A computer-readable medium which stores a set of instructions which when executed on a processor performs a method for providing a combination gift element and greeting element, the method executed by the set of instructions comprising:
receiving a request to create a gift element with the greeting element;
receiving a request to associate a gift element with the greeting element; and
creating the combination gift element and greeting element based upon the received request to create the greeting element and the received request to associate the gift element with the greeting element,
wherein creating the combination gift element and greeting element employs the involvement of multiple entities.

25. The computer-readable medium of claim 24, further comprising receiving the request to create the combination gift element and greeting element from a retailer.

26. The computer-readable medium of claim 25, further comprising transferring the request to create the combination gift element and greeting element from a retailer to a third party.

27. The computer-readable medium of claim 25, further comprising transmitting authorization to the retailer and to the third party, by the service provider, to create the combination gift element and greeting element.

28. The computer-readable medium of claim 24, further comprising receiving the request to create the combination gift element and greeting element at a service provider.

29. The computer-readable medium of claim 28, further comprising transferring the request to create the combination gift element and greeting element from a service provider to a third party.

30. The computer-readable medium of claim 28, further comprising transmitting authorization for the third party to offer a retailer gift element by the retailer.

31. The computer-readable medium of claim 24, further comprising initiating the request to create the combination gift element and greeting element at a third party.

32. The computer-readable medium of claim 31, further comprising transmitting authorization to the third party to offer a retailer gift element by the retailer.

33. The computer-readable medium of claim 31, further comprising transmitting authorization to the third party, by the service provider, to create the combination gift element and greeting element.

34. The computer-readable medium of claim 24, wherein the gift element is a retailer gift element.

35. The computer-readable medium of claim 24, further comprising configuring the combination gift element and greeting element to be sent over at least one of a network and an item delivery system, by the third party.

36. The computer-readable medium of claim 24, further comprising implementing a network to acquire information about the combination gift element and greeting element, by a recipient.

37. The computer-readable medium of claim 24, further comprising implementing a network to submit information about the combination gift element and greeting element, by a recipient.

38. The computer-readable medium of claim 24, further comprising receiving a request to personalize the greeting element with an image.

39. The computer-readable medium of claim 24, further comprising receiving a request to personalize a stamp for an envelope containing the combination gift element and greeting element with an image.

40. The computer-readable medium of claim 24, further comprising receiving a request to associate a photographic print with the combination gift element and greeting element.

41. The computer-readable medium of claim 24, further comprising including a tracking indicia on an envelope containing the combination gift element and greeting element.

42. The computer-readable medium of claim 24, further comprising collecting a fee by a third party.

43. The computer-readable medium of claim 42, further comprising the third party sharing the fee with a retailer and a service provider.
